(19) United States
(12) Patent Application Publication
(10) Pub. No.: US 2022/0317521 A1
(43) Pub. Date: Oct. 6, 2022

(54) DISPLAY PANEL, METHOD OF FABRICATING DISPLAY PANEL, AND DISPLAY DEVICE

(71) Applicant: TCL CHINA STAR OPTOELECTRONICS TECHNOLOGY CO., LTD., Shenzhen, Guangdong (CN)

(72) Inventor: Xingwu CHEN, Shenzhen, Guangdong (CN)

(21) Appl. No.: 16/759,421

(22) PCT Filed: Apr. 10, 2020
(86) PCT No.: PCT/CN2020/084129

§ 371 Date: Apr. 27, 2020

(30) Foreign Application Priority Data
Mar. 3, 2020 (CN) 202010139386.X

(51) Int. Cl. G02F 1/1343; G02F 1/1337; G02F 1/1335

(52) U.S. Cl. CPC G02F 1/134309; G02F 1/133707; G02F 1/133516

(57) ABSTRACT

Embodiments of the present application provide a display panel, a method of fabricating the display panel, and a display device. The display panel includes an array substrate, a color filter substrate, and a liquid crystal layer. A pixel electrode layer is provided on a side of the array substrate, and the pixel electrode layer includes a plurality of slits. The color filter substrate and the array substrate are provided with pixel electrode layers on sides opposite to each other, and the color filter substrate is provided with a common electrode layer on a side facing the array substrate. The liquid crystal layer is provided between the array substrate and the color filter substrate, and the liquid crystal layer includes liquid crystals and a chiral agent.

The present application claims priority to Chinese Patent Application No. 202010139386.X, titled “Display panel and Display Device”, filed on Mar. 3, 2020 with the National Intellectual Property Administration, which is incorporated by reference in the present application in its entirety.

### FIELD OF INVENTION

The present invention relates to a display technology, and more particularly, to a display panel, a method of fabricating the display panel, and a display device

### BACKGROUND

In prior art, liquid crystal display technologies of display panels can be generally divided into several modes such as twist nematic (TN) mode, vertical alignment (VA) mode, in-plane switching (IPS) mode, and fringe-field switching (FFS) mode. Among them, polymer stabilized vertical alignment (PSVA) liquid crystal display is widely used due to its advantages of high contrast and fast response times.

### TECHNICAL PROBLEM

With development of science and technology, people have higher and higher demands for display technology. Wide viewing angles and high transmittance of display panels are important directions for future development. However, penetration rates of display panels using the PSVA mode are low, and fail to meet people's needs.

### TECHNICAL SOLUTION

In a first aspect, embodiments of the present application provide a display panel, a method of fabricating a display panel, and a display device, which aim to improve the structure of the display panel, while making the display panel have higher contrasts, response speeds, and high transmittance.

To solve the above problems, in a first aspect, the present application provides a display panel, wherein the display panel comprises:
an array substrate having a pixel electrode layer disposed on a side of the array substrate, wherein the pixel electrode layer has a plurality of slits;
a color filter substrate disposing opposite to the side of the array substrate on which the pixel electrode layer is disposed, and a common electrode layer is disposed on a side of the color filter substrate facing the array substrate; and
a liquid crystal layer disposed between the array substrate and the color filter substrate, wherein the liquid crystal layer comprises liquid crystals and a chiral agent.

In some embodiments of the present application, an optical path length difference of the display panel is greater than or equal to 300 mm and less than or equal to 550 mm

In some embodiments of the present application, a box thickness of the display panel is greater than or equal to 2.5 μm and less than or equal to 10 μm.

In some embodiments of the present application, a pitch of the liquid crystals is greater than or equal to 5 μm and less than or equal to 120 μm.

In some embodiments of the present application, a side of the common electrode layer facing the array substrate is further disposed with a first alignment layer, and a pretilt angle of the first alignment layer is greater than or equal to 0.1° and less than or equal to 5°.

In some embodiments of the present application, the first alignment layer is a photo alignment layer.

In some embodiments of the present application, the array substrate further comprises a second alignment layer, and the second alignment layer is disposed on a side of the pixel electrode layer facing the color filter substrate.

In some embodiments of the present application, a content of the chiral agent is greater than or equal to 0.005% and less than or equal to 30%.

In some embodiments of the present application, the liquid crystals are a negative liquid crystal compound.

In some embodiments of the present application, the pixel electrode layer comprises a plurality of pixel electrodes, and the pixel electrodes comprise a plurality of display domain regions, and each of the display domain regions comprises a plurality of the slits, and extending directions of the slits in two adjacent display domain regions are set at an angle.

In a second aspect, the present application further provides a method of fabricating a display panel, wherein the method comprises:
providing an array substrate, wherein a pixel electrode layer is disposed on a side of the array substrate, and the pixel electrode layer has a plurality of slits;
providing a color filter substrate, wherein a common electrode layer is disposed on a side of the color filter substrate facing the array substrate;
stacking the array substrate and the color filter substrate to form a liquid crystal box; and
injecting liquid crystals containing a chiral agent into the liquid crystal box to form the display panel.

In a third aspect, the present application further provides a display device, wherein comprises the display panel described above, and the display panel comprises:
an array substrate having a pixel electrode layer disposed on a side of the array substrate, wherein the pixel electrode layer has a plurality of slits;
a color filter substrate disposing opposite to the side of the array substrate on which the pixel electrode layer is disposed, and a common electrode layer is disposed on a side of the color filter substrate facing the array substrate; and
a liquid crystal layer disposed between the array substrate and the color filter substrate, wherein the liquid crystal layer comprises liquid crystals and a chiral agent.

In some embodiments of the present application, an optical path length difference of the display panel is greater than or equal to 300 mm and less than or equal to 550 mm

In some embodiments of the present application, a box thickness of the display panel is greater than or equal to 2.5 μm and less than or equal to 10 μm.

In some embodiments of the present application, a pitch of the liquid crystals is greater than or equal to 5 μm and less than or equal to 120 μm.

In some embodiments of the present application, a side of the common electrode layer facing the array substrate is further disposed with an alignment layer, and a pretilt angle of the alignment layer is greater than or equal to 0.1° and less than or equal to 5°.

In some embodiments of the present application, the alignment layer is a photo alignment layer.

In some embodiments of the present application, the liquid crystals are a negative liquid crystal compound.

In some embodiments of the present application, the pixel electrode layer comprises a plurality of pixel electrodes, and the pixel electrodes comprise a plurality of display domain regions, and each of the display domain regions comprises a plurality of the slits, and extending directions of the slits in two adjacent display domain regions are set at an angle.

### ADVANTAGEOUS EFFECTS

The display panel according to embodiments of the present application comprises an array substrate and a color filter substrate. A pixel electrode layer is disposed on a side of the array substrate, and the pixel electrode layer has a plurality of slits. A common electrode is disposed on a side of the color filter substrate facing the array substrate, and a liquid crystal layer is disposed between the array substrate and the color filter substrate to form a display panel of a polymer stable vertical arrangement mode, so that the display panel has wider viewing angles, higher contrasts, and response times. Moreover, the liquid crystal layer further comprises liquid crystals and a chiral agent. When voltages are applied to the pixel electrode layer of the array substrate and the common electrode layer of the color filter substrate simultaneously, the liquid crystals in the liquid crystal layer will tilt along a slit direction of the pixel electrode layer. At the same time, the chiral agent in the liquid crystal can induce the liquid crystals to rotate, and finally makes a rotation angle of the liquid crystals close to or equal to π/2 or 3π/2, so as to maximize the transmittance of the display panel.

### BRIEF DESCRIPTION OF DRAWINGS

To detailly explain the technical schemes of the embodiments or existing techniques, drawings that are used to illustrate the embodiments or existing techniques are provided. Apparently, the illustrated embodiments are just a part of those of the present disclosure. It is easy for any person having ordinary skill in the art to obtain other drawings without labor for inventiveness.

FIG. 1 is a cross-sectional view of an embodiment of a display panel provided by an embodiment of the present application.

FIG. 2 is a schematic structural diagram of an embodiment of a pixel electrode provided by an embodiment of the present application.

FIG. 3 is a schematic structural diagram of another embodiment of a pixel electrode provided by an embodiment of the present application.

FIG. 4 is a schematic structural diagram of an embodiment of a color filter substrate provided by an embodiment of the present application.

FIG. 5 is a schematic flowchart of an embodiment of a method of fabricating a display panel according to an embodiment of the present application.

display panel 100; array substrate 110; pixel electrode layer 111; pixel electrode layer 111a; pixel electrode 1110; pixel electrode 1110a; slit 1111; slit 1111a; display domain region 1112; trunk 1113; first substrate 112; second alignment Layer 113; first polarizing layer 114; color filter substrate 120; common electrode layer 121; second substrate 122; first alignment layer 123; second polarizing layer 124; alignment substrate 125; liquid crystal layer 130; liquid crystals 131; polymerizable monomer 132.

### DETAILED DESCRIPTION

Please refer to the drawings, in which the same reference numerals represent the same components. The following description is based on specific embodiments of the present application as illustrated and should not be construed as limiting the specific embodiments that are not described herein.

The following description is based on the specific embodiments of the present application as illustrated and should not be construed as limiting the specific embodiments that are not described herein. The directional terms mentioned in the present application, such as “upper”, “lower”, “before”, “after”, “left”, “right”, “inside”, “outside”, “side”, etc., are only used to show direction in the figures. The directional terms used in the drawings are used to explain and explain the invention and are not intended to limit the scope of the invention. In addition, the terms “first” and “second” are used for descriptive purposes only, and cannot be understood as indicating or implying relative importance or implicitly indicating the number of technical features indicated. Therefore, the features defined as “first” and “second” may explicitly or implicitly include one or more of the features. In the description of the present application, the meaning of “a plurality” is two or more, unless specifically defined otherwise.

In this application, the word “exemplary” is used to mean “serving as an example, illustration, or illustration.” Any embodiment described as “exemplary” in this application is not necessarily to be construed as preferred or advantageous over other embodiments. In order to enable any person skilled in the art to implement and use the present application, the following description is given. In the following description, details are set forth for the purpose of explanation. It should be understood by those of ordinary skill in the art that the present application can be implemented without the use of these specific details. In other instances, well-known structures and procedures will not be described in detail to avoid unnecessary details making the description of this application obscure. Therefore, this application is not intended to be limited to the embodiments shown, but is to be accorded the widest scope consistent with the principles and features disclosed herein.

Embodiments of the present application provide a display panel, a method of fabricating the display panel, and a display device. Each of them will be described in detail below.

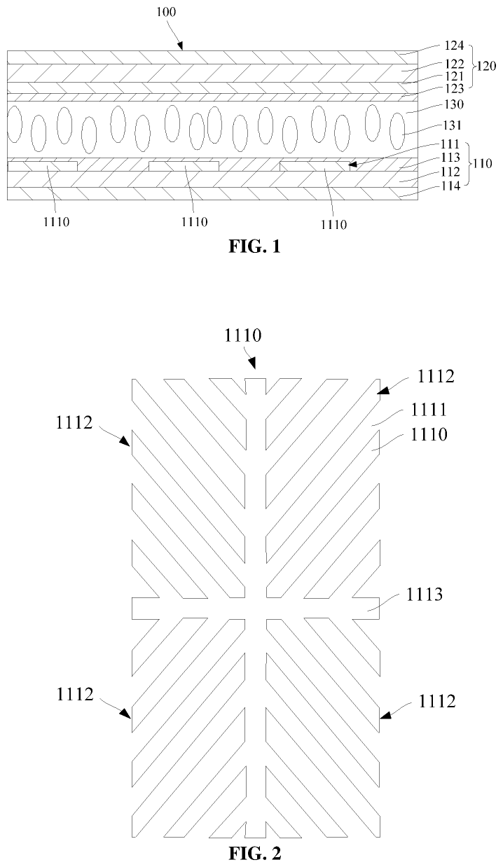

As shown in FIG. 1, the display panel 100 comprises an array substrate 110 and a color filter substrate 120, and a pixel electrode layer 111 is provided on a side of the array substrate 110. The color filter substrate 120 is opposite to the side of the array substrate 110 on which the pixel electrode layer 111 is disposed, and a common electrode layer 121 is disposed on a side of the color filter substrate 120 facing the array substrate 110. A liquid crystal layer 130 is further disposed between the array substrate 110 and the color filter substrate 120. The liquid crystal layer 130 comprises liquid crystals 131.

The pixel electrode layer 111 on the array substrate 110 has a plurality of slits 1111 to form a display panel 100 having polymer stabilized vertical alignment (PSVA) type liquid crystals 131. When a voltage is applied to the pixel electrode layer 111 of the array substrate 110 and the common electrode layer 121 of the color filter substrate 120 at the same time, the liquid crystals 131 in the liquid crystal layer 130 will fall along a direction of the slits 1111 of the pixel electrode layer 111, so that the liquid crystals 131 have wider viewing angles, higher contrasts, and faster response times.

In some embodiments, the pixel electrode layer 111 comprises a plurality of pixel electrodes 1110. The pixel electrodes 1110 comprise a plurality of display domain regions 1112. Each display domain region 1112 comprises a plurality of slits 1111. Extending directions of the slits 1111 of two adjacent display domain regions 1112 are set at an angle. When a voltage is applied to the pixel electrode layer 111 of the array substrate 110 and the common electrode layer 121 of the color filter substrate 120 at the same time, molecules of the liquid crystals 131 in the different display domain regions 1112 are tilted in different directions, thereby enlarging viewing angles of the display panel 100 and making image effect seen in all directions apt to be uniform and consistent.

Specifically, as shown in FIG. 2, the pixel electrode 1110 comprises a trunk 1113 arranged in a cross “+” shape. The trunk 1113 divides a sub-pixel into four display domain regions 1112. Each display domain region 1112 has the plurality of slits 1111 extending along different directions in the trunk 1113. The plurality of slits 1111 in the same display domain region 1112 are parallel to each other. The slits 1111 in two adjacent display domain regions 1112 extend in different directions. The slit 1111 in the display domain region 1112 in the upper left corner of the pixel is inclined upward and left, having an upward tilt angle of 45°. The slits 1111 in the display domain region 1112 in the upper right corner of the sub-pixel are inclined along the upper right direction, having an upward tilt angle of 45°. The slits 1111 in the display domain region 1112 in the lower right corner of the sub-pixel are inclined along the lower right direction, having a downward tilt angle of 45°.

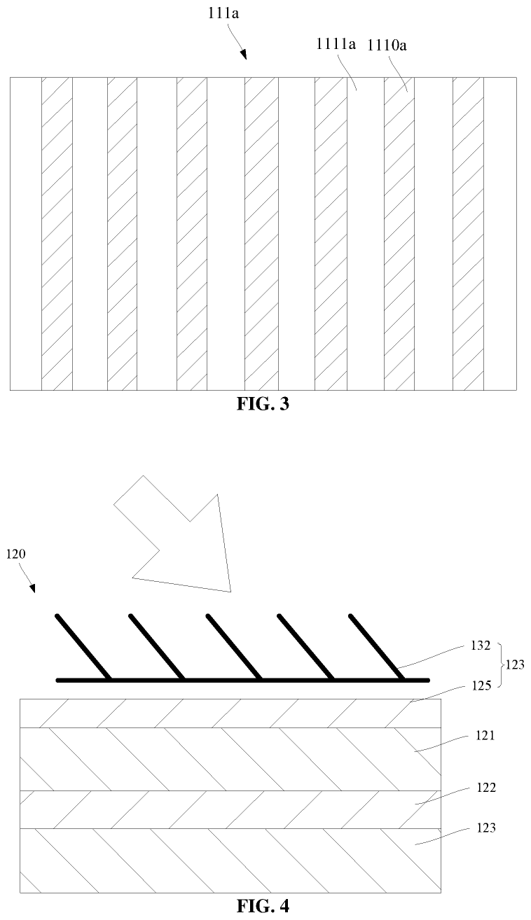

In other embodiments, as shown in FIG. 3, the pixel electrode layer 111a comprises a plurality of pixel electrodes 1110a, and a plurality of slits 1111a in each pixel electrode 1110a extend along a straight line, and two adjacent slits 1111a are parallel to each other.

In some embodiments, the array substrate 110 comprises a first substrate 112, a thin film transistor layer (not shown) disposed on a side of the first substrate 112, and a passivation layer and a pixel electrode layer 111 sequentially disposed on a side of the thin film transistor layer facing away from the first substrate 112, and the pixel electrode layer 111 is in contact with the thin film transistor layer through a via hole on the passivation layer. Specifically, the thin film transistor layer comprises a gate layer, a gate insulating layer, an active layer, and a source-drain layer sequentially disposed on the first substrate 112 to form a plurality of thin-film transistor structures. The passivation layer covers the source-drain layer from above, and the pixel electrode layer 111 comprises a plurality of pixel electrodes 1110. Each pixel electrode 1110 is in contact with a source-drain layer of a corresponding thin film transistor through a via hole in the passivation layer.

It should be noted that, in addition to the above structure, the array substrate 110 may also comprise any other necessary structures as needed, such as optical layers like a buffer layer, an interlayer dielectric layer (ILD), and the like disposed on the first substrate 112, but are not limited here.

The first substrate 112 is a transparent substrate. Specifically, it can be a transparent glass substrate, or a transparent flexible substrate made of polyimide (PI), polyethylene terephthalate (PET), copolymers of cycloolefin (COC), or polyethersulfone resin (PES) and other materials.

In some embodiments, the color filter substrate 120 comprises a second substrate 122, and a color resist layer (not shown in the figure) disposed on a side of the second substrate 122 facing the liquid crystal layer 130, and a common electrode layer 121 is provided on a side of the color resist layer faces away from the second basic layer. The color resist layer comprises a plurality of pixel units, and each pixel unit comprises a plurality of sub-pixel units of different colors. The plurality of sub-pixel units on the color filter substrate 120 correspond to the plurality of pixel electrodes 1110 on the array substrate 110 one by one.

The second substrate 122 is a transparent substrate. Specifically, it can be a transparent glass substrate, or a transparent flexible substrate made of polyimide (PI), polyethylene terephthalate (PET), copolymers of cycloolefin (COC), or polyethersulfone resin (PES) and other materials.

In some embodiments, a plastic frame (not shown) is further disposed between the array substrate 110 and the color filter substrate 120 of the display panel 100, and the plastic frame is sandwiched between the array substrate 110 and the color filter substrate 120. The plastic frame is disposed around the liquid crystal layer 130 to prevent the liquid crystals 131 in the liquid crystal layer 130 from leaking. In addition, a first polarizing layer 114 is further disposed on a side of the array substrate 110 facing away from the liquid crystal layer 130, and a second polarizing layer 124 is also disposed on a side of the color filter substrate 120 facing away from the liquid crystal layer 130.

In some embodiments, the liquid crystal layer 130 further comprises a chiral agent. By adding the chiral agent to the liquid crystals 131 of the liquid crystal layer 130, the liquid crystals 131 in the liquid crystal layer 130 can be induced to rotate, and finally a rotation angle of the liquid crystals 131 is close to or equal to π/2 or π/2, so that transmission of the display panel 100 is maximized Among them, the chiral agent comprises chiral agent S811, chiral agent R811, chiral agent S1011, chiral agent R1011, or fluorine-containing chiral agent, and the like, and is not limited herein.

In some embodiments, a content of the chiral agent in the liquid crystal layer 130 is greater than or equal to 0.005%, so that the chiral agent added to the liquid crystals 131 has a better effect of improving the transmittance of the display panel 100. In addition, the content of the chiral agent in the liquid crystal layer 130 is less than or equal to 30%, so as to avoid increasing the viscosity of the liquid crystals 131 after the content of the chiral agent in the liquid crystal layer 130 is too high, which further affects the response times of the liquid crystals 131.

In some embodiments, the liquid crystals 131 are negative liquid crystals 131, so that the liquid crystals 131 can more accurately rotate the angle to π/2 or π/2 under the induction of the chiral agent.

In some embodiments, an optical path length difference of the display panel 100 is greater than or equal to 300 mm and less than or equal to 550 mm. The optical path length difference of the display panel 100 is a product And of a refractive index anisotropy Δn of the liquid crystals 131 in the display panel 100 and a box thickness d of the display panel 100. By making the optical path length difference of the display panel 100 greater than or equal to 300 mm and less than or equal to 550 mm, that is, 300 mm≤Δnd≤550 mm, the transmittance of the display panel 100 per unit area can be further improved.

In some embodiments, the box thickness of the display panel 100 is less than or equal to 10 μm, so that the display panel 100 has faster response times. In addition, the box thickness of the display panel 100 is greater than or equal to 2.5 μm to reduce the requirement for the refractive index anisotropy of the liquid crystals 131.

In some embodiments, a pitch of the liquid crystal 131 is greater than or equal to 5 μm, and less than or equal to 120 μm, so as to reduce the dark pattern area around the pixel electrode 1110 of the array substrate 110, thereby improving the transmittance of the display panel 100.

In some embodiments, the color filter substrate 120 further comprises a first alignment layer 123. The first alignment layer 123 is disposed on a side of the common electrode layer 121 facing the array substrate 110. The color filter substrate 120 induces liquid crystals 131 to fall along a direction perpendicular to the slits 1111 of the pixel electrode layer 111 through the first alignment layer 123. A pre-tilt angle of the first alignment layer 123 is greater than or equal to 0.1° and less than or equal to 5°, so that the liquid crystals 131 are more accurately rotated to π/2 or π/2. The first alignment layer 123 is made of polyimide (PI) material.

In some embodiments, the first alignment layer 123 is a photo alignment layer to improve the yield of the display panel 100. Specifically, the liquid crystals 131 of the liquid crystal layer 130 are doped with polymerizable monomers 132 such as acrylates and epoxy resins, and the surface of the common electrode of the color filter substrate 120 facing the array substrate 110 is coated with polyimide (PI) as the alignment substrate 125. Thereafter, as shown in FIG. 4, when a voltage is applied and ultraviolet (UV) light is irradiated on the color filter substrate 120 along the direction of the arrow, the polymerizable monomers 132 and molecules of the liquid crystals 131 in the liquid crystal layer 130 undergo phase separation, and a polymer is formed on the alignment substrate 125 of the color filter substrate 120 to form a first alignment layer 123. Due to the interaction between the polymer and molecules of the liquid crystal 131, molecules of the liquid crystals 131 are aligned along the direction of the polymerized molecules. Therefore, by controlling the tilt angle of the polymer of the first alignment layer 123, that is, controlling the pretilt angle of the first alignment layer 123, molecules of the liquid crystals 131 in the liquid crystal layer 130 can also have a pretilt angle.

In some embodiments, the array substrate 110 further comprises a second alignment layer 113. The second alignment layer 113 is disposed on a side of the pixel electrode 1110 facing the color filter substrate 120. The array substrate 110 comprises the liquid crystals 131 along the second alignment layer 113. The array substrate 110 induces liquid crystals 131 to fall along a direction perpendicular to the slits 1111 of the pixel electrode layer 111 through the second alignment layer 113.

The second alignment layer 113 may be formed by a rubbing alignment method. The rubbing alignment method is a method for forming an alignment layer commonly used in the prior art, and is not repeated here. Alternatively, the second alignment layer 113 may be formed by a photo alignment method, that is, the second alignment layer 113 is a photo alignment layer. The specific process of forming the second alignment layer 113 by the photo-alignment method can refer to the above-mentioned process of forming the first alignment layer 123 by the photo-optical alignment method, which will not be repeated here.

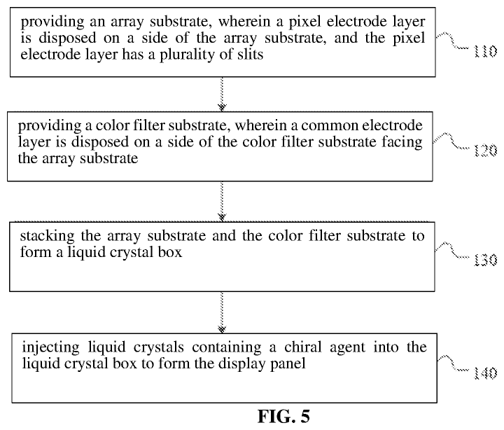

An embodiment of the present application further provides a method of fabricating a display panel. As shown in FIG. 5, the method of fabricating the display panel comprises following steps:

110: providing an array substrate, wherein a pixel electrode layer is disposed on a side of the array substrate, and the pixel electrode layer has a plurality of slits.

In some embodiments, the process of providing the array substrate may specifically comprises following steps:
1) Providing a first substrate.

Materials of the first substrate may be referenced from the foregoing embodiments, and details are not described herein again.
2) Sequentially forming a thin film transistor layer, a passivation layer, and a pixel electrode layer on the first substrate.

Structures of the thin film transistor layer, the passivation layer, and the pixel electrode layer can be referenced from the foregoing embodiments, and details are not described herein again.

120: providing a color filter substrate, wherein a common electrode layer is disposed on a side of the color filter substrate facing the array substrate

In some embodiments, the process of providing a color filter substrate may specifically comprise following steps:
1) Providing a second substrate, and a structure of the second substrate can be referenced from the foregoing embodiments.
2) Sequentially forming a color resist layer and a common electrode layer on a side of the second substrate facing the array substrate.

130: stacking the array substrate and the color filter substrate to form a liquid crystal box.

140: injecting liquid crystals containing a chiral agent into the liquid crystal box to form the display panel.

In some embodiments, liquid crystals containing the chiral agent may be injected into the liquid crystal cell by an inkjet printing (IJP) method or other methods to form a liquid crystal layer between the array substrate and the display panel.

The method of fabricating the display panel provided in the embodiments of the present application allows the array substrate, the color filter substrate, and the liquid crystal layer therebetween to form a display panel of a polymer stabilized vertically arrangement mode by providing a pixel electrode layer having a plurality of slits on the side of the array substrate, so that the display panel has wider viewing angles, higher contrast ratios, and faster response times. Moreover, the liquid crystal layer also comprises a chiral agent for a liquid crystal box. When voltage is applied to the pixel electrode layer of the array substrate and the common electrode layer of the color filter substrate simultaneously, the liquid crystals in the liquid crystal layer will fall along the slit direction of the pixel electrode layer. At the same time, the chiral agent contained in the liquid crystals can induce the liquid crystals to rotate, and finally makes the rotation angle of the liquid crystals close to or equal to π/2 or π/2, so as to maximize the transmittance of the display panel.

In some embodiments, the liquid crystal layer comprises a polymerizable monomer, and injecting liquid crystals containing a chiral agent into the liquid crystal box to form the display panel comprises performing a first UV irradiation on the display panel to form a pretilt angle. After that, the display panel is subjected to a second UV irradiation to make the polymerizable monomers in the liquid crystal layer react completely and improve the stability of the display panel.

An embodiment of the present application further provides a display device. The display device comprises the display panel described above, or a method of fabricating the display panel by the display panel manufacturing method described above. For the specific structure or fabrication method of the display panel, refer to the foregoing. In this embodiment, since the display device adopts all the technical solutions of all the embodiments described above, it has at least all the beneficial effects brought by the technical solutions of the above embodiments, which will not be repeated one by one here.

The display device comprises a television, a display, a tablet computer, and the like, which are not limited herein.

In the above embodiments, the description of each embodiment has its own emphasis. For the parts that are not described in detail in an embodiment, refer to the detailed descriptions of other embodiments above, which will not be repeated here.

In specific implementation, each of the above units or structures may be implemented as independent entities, or any combination may be implemented as the same or several entities. For the specific implementation of the above units or structures, refer to the foregoing method embodiments, which will not be repeated here.

For specific implementation of the foregoing operations, refer to the foregoing embodiments, and details are not described herein again.

The display panel, the method of fabricating the display panel, and the display device provided in the embodiments of the present application have been described in detail above. The specific examples are used herein to explain the principles and implementation of the present application. The description of the above embodiments is only used to help understand the method of the application and its core ideas; at the same time, for those skilled in the art, according to the ideas of the application, there will be changes in the specific implementation and application scope. In summary, this description and the content should not be construed as a limitation on this application.

What is claimed is:

1. A display panel, wherein the display panel comprises:
an array substrate having a pixel electrode layer disposed on a side of the array substrate, wherein the pixel electrode layer has a plurality of slits;
a color filter substrate disposed opposite to the side of the array substrate on which the pixel electrode layer is disposed, and a common electrode layer disposed on a side of the color filter substrate facing the array substrate; and
a liquid crystal layer disposed between the array substrate and the color filter substrate, wherein the liquid crystal layer comprises liquid crystals and a chiral agent.

2. The display panel according to claim 1, wherein an optical path length difference of the display panel is greater than or equal to 300 mm and less than or equal to 550 mm.

3. The display panel according to claim 2, wherein a box thickness of the display panel is greater than or equal to 2.5 μm and less than or equal to 10 μm.

4. The display panel according to claim 1, wherein a pitch of the liquid crystals is greater than or equal to 5 μm and less than or equal to 120 μm.

5. The display panel according to claim 1, wherein a side of the common electrode layer facing the array substrate is further disposed with a first alignment layer, and a pretilt angle of the first alignment layer is greater than or equal to 0.1° and less than or equal to 5°.

6. The display panel according to claim 5, wherein the first alignment layer is a photo alignment layer.

7. The display panel according to claim 1, wherein the array substrate further comprises a second alignment layer, and the second alignment layer is disposed on a side of the pixel electrode layer facing the color filter substrate.

8. The display panel according to claim 1, wherein a content of the chiral agent is greater than or equal to 0.005% and less than or equal to 30%.

9. The display panel according to claim 1, wherein the liquid crystals are negative liquid crystals.

10. The display panel according to claim 1, wherein the pixel electrode layer comprises a plurality of pixel electrodes, the pixel electrodes comprise a plurality of display domain regions, and each of the display domain regions comprises the plurality of slits, and extending directions of the slits in two adjacent display domain regions are set at an angle.

11. A method of fabricating a display panel, wherein the method comprises:
providing an array substrate, wherein a pixel electrode layer is disposed on a side of the array substrate, and the pixel electrode layer has a plurality of slits;
providing a color filter substrate, wherein a common electrode layer is disposed on a side of the color filter substrate facing the array substrate;
stacking the array substrate and the color filter substrate to form a liquid crystal box; and
injecting liquid crystals containing a chiral agent into the liquid crystal box to form the display panel.

12. A display device, wherein the display device comprises a display panel, and the display panel comprises:
an array substrate having a pixel electrode layer disposed on a side of the array substrate, wherein the pixel electrode layer has a plurality of slits;
a color filter substrate disposed opposite to the side of the array substrate on which the pixel electrode layer is disposed, and a common electrode layer disposed on a side of the color filter substrate facing the array substrate; and
a liquid crystal layer disposed between the array substrate and the color filter substrate, wherein the liquid crystal layer comprises liquid crystals and a chiral agent.

13. The display device according to claim 12, wherein an optical path length difference of the display panel is greater than or equal to 300 mm and less than or equal to 550 mm.

14. The display device according to claim 13, wherein a box thickness of the display panel is greater than or equal to 2.5 μm and less than or equal to 10 μm.

15. The display device according to claim 12, wherein a pitch of the liquid crystals is greater than or equal to 5 μm and less than or equal to 120 μm.

16. The display device according to claim 12, wherein a side of the common electrode layer facing the array substrate is further disposed with an alignment layer, and a pretilt angle of the alignment layer is greater than or equal to 0.1° and less than or equal to 5°.

17. The display device according to claim 16, wherein the alignment layer is a photo alignment layer.

18. The display device according to claim 12, wherein a content of the chiral agent is greater than or equal to 0.005% and less than or equal to 30%.

19. The display device according to claim 12, wherein the liquid crystals are negative liquid crystals.

20. The display device according to claim 12, wherein the pixel electrode layer comprises a plurality of pixel electrodes, the pixel electrodes comprise a plurality of display domain regions, and each of the display domain regions comprises the plurality of slits, and extending directions of the slits in two adjacent display domain regions are set at an angle.
